(19) United States
(12) Patent Application Publication
(10) Pub. No.: US 2026/0163030 A1
(43) Pub. Date: Jun. 11, 2026

(54) METHOD FOR OPERATING A FUEL CELL SYSTEM, AND FUEL CELL SYSTEM

(71) Applicant: Robert Bosch GmbH, Stuttgart (DE)

(72) Inventor: Helerson Kemmer, Vaihingen (DE)

(21) Appl. No.: 18/716,304

(22) PCT Filed: Dec. 5, 2022
(86) PCT No.: PCT/EP2022/084352

§ 371 Date: Jun. 4, 2024

(30) Foreign Application Priority Data
Dec. 20, 2021 (DE) 10 2021 214 682.1

(51) Int. Cl. H01M 8/04223; H01M 8/04119; H01M 8/04225; H01M 8/04228; H01M 8/249

(52) U.S. Cl. CPC H01M 8/04231; H01M 8/04156; H01M 8/04225; H01M 8/04228; H01M 8/249

(57) ABSTRACT

The invention relates to a method for operating a fuel cell system (1) having multiple fuel cell stacks (100, 200) which each have a cathode (110, 210) and an anode (120, 220), the cathodes (110, 210) each being fed with air via a feed air path (111, 211), and exhaust air emitted from the fuel cell stacks (100, 200) being discharged via an exhaust air path (112, 212), and the anodes (120, 220) each being supplied with hydrogen via an anode circuit (121, 221). According to the invention, when starting up and/or shutting down the fuel cell system (1), the exhaust air emitted from a fuel cell stack (100) is used for inerting the anode (220) and/or the cathode (210) of another fuel cell stack (200).

The invention also relates to a fuel cell system (1) for carrying out the method.

### BACKGROUND

The invention relates to a method for operating a fuel cell system. The invention further relates to a fuel cell system suitable for performing the method according to the invention or for operation according to the method.

Preferred areas of application are fuel cell vehicles, preferably fuel cell vehicles with start-stop operation.

Fuel cells are electrochemical energy converters. In particular, hydrogen (H₂) and oxygen (O₂) can be used as reaction gases. These are converted into electrical energy, water (H₂O) and heat with the aid of a fuel cell. The core of a fuel cell is a membrane electrode assembly (MEA), which comprises a membrane coated on both sides with a catalytic material to form electrodes. During operation of the fuel cell, hydrogen is fed to one electrode, the anode, and oxygen to the other electrode, the cathode.

In practice, a large number of fuel cells are connected to form a fuel cell stack in order to increase the electrical output. In addition, multiple fuel cell stacks or fuel cell systems can be interconnected.

During operation of a fuel cell system, start and/or stop phases represent a high load that can lead to degradation of the fuel cells. At the start, the main cause of this is a hydrogen-air front in the anode. When stopping or shutting down, it is a high voltage that is present due to the fact that the anode is supplied with hydrogen and the cathode with oxygen without an electrical load being drawn from the stack. This can occur in particular during long shutdown phases.

In order to counteract the degradation of the fuel cells in a start and/or stop phase, the oxygen present in the cathode can be consumed before the system is shut down by drawing electrical current without additional air supply. Meanwhile, the anode continues to be supplied with hydrogen so that the cell voltages are not critical. However, if air diffuses into the cathode, the cell voltages increase and remain there for several hours, causing damaging electrochemical reactions. As a rule, shut-off valves are therefore provided on both the inlet and outlet sides to prevent air from entering the cathode in the event of a shutdown. However, as these are not completely sealed, especially over their service life, their effectiveness is limited. Furthermore, the shut-off valves are associated with a not insignificant pressure loss.

It is known from stationary applications to inert the anode and possibly the cathode with nitrogen before starting and/or shutting down in order to counteract undesired degradation. The nitrogen is stored in a bottle for this purpose. However, this is not possible in mobile applications for reasons of space. Furthermore, a nitrogen cylinder has to be refilled and maintained, which has a negative impact on costs.

### SUMMARY

The present invention is concerned with the task of enabling inerting in mobile fuel cell systems in order to counteract degradation of the fuel cells.

A method is proposed for operating a fuel cell system with multiple fuel cell stacks, each of which has a cathode and an anode. Air is fed to the cathodes via a feed air path and exhaust air emitted from the fuel cell stacks is discharged via an exhaust air path. The anodes are each supplied with hydrogen via an anode circuit. According to the invention, the exhaust air emitted from a fuel cell stack is used to inert the anode and/or the cathode of another fuel cell stack when starting and/or shutting down the fuel cell system.

The exhaust air from a fuel cell stack is oxygen-free or at least low in oxygen, so that it is suitable for inerting an anode and/or cathode of another fuel cell stack. In the proposed method, the exhaust air from a first fuel cell stack is therefore used to inert a second fuel cell stack during start-up and/or shutdown.

The method according to the invention can be used to effectively eliminate or at least reduce the stack degradation that occurs when starting and/or stopping. As a result, the service life of the stack is increased. A further advantage is that no additional gas, for example nitrogen, has to be provided for inerting, so that the installation space requirement of the fuel cell system remains essentially unchanged.

Preferably, the exhaust air from one fuel cell stack required for inerting is fed to the other fuel cell stack via a connecting line with an integrated shut-off valve, which is opened for this purpose. In the simplest case, therefore, only one further line and one further valve are required to carry out the method according to the invention, so that the additional installation space required is negligible. The method can therefore be implemented very simply and cost-effectively.

Furthermore, the exhaust air of a fuel cell stack required for inerting is preferably fed directly or indirectly to the anode or the cathode of the other fuel cell stack, with indirect feeding preferably taking place via the anode circuit or the feed air path of the other fuel cell stack, depending on whether the anode or the cathode is to be inerted. In the case of indirect feed, the proposed connecting line with integrated shut-off valve therefore opens into the anode circuit or into the feed air path of the fuel cell stack to be inerted.

Furthermore, it is proposed that when the fuel cell system is started and/or shut down, the air supply to the fuel cell stack to be inerted is interrupted by switching off an air conveying and air compression system and/or by closing at least one shut-off valve. This ensures that no air or oxygen gets into the cathode of the fuel cell stack to be inerted. The closing of at least one shut-off valve presupposes that such a valve is present at all. Depending on the design of the fuel cell stack or fuel cell system, this is not absolutely necessary. The implementation of the method according to the invention does not require any shut-off valves for shutting off the cathode, so that shut-off valves in the feed air and/or exhaust air path can be dispensed with. This means that the costs for the shut-off valves can be saved. As a result, there is also no pressure loss, so that the proposed method can also reduce the consumption of hydrogen.

By opening a purge valve and/or drain valve integrated in the anode circuit, anode gas from an inerted anode can be removed from the fuel cell system. Alternatively, the anode gas of an inerted anode can be fed into an exhaust air path of a fuel cell stack via a connecting line when the purge and/or drain valve is open. This may be the same fuel cell stack or a different one. The anode gas then mixes with the exhaust air in the exhaust air line and can be discharged as an inert gas mixture.

According to a preferred embodiment of the invention, the exhaust air required for inerting is generated by sub-stoichiometric operation of a fuel cell stack.

A fuel cell system with multiple fuel cell stacks is also proposed to solve the problem mentioned at the beginning. The multiple fuel cell stacks each have a cathode and an anode. The cathodes are each connected to a feed air path on the inlet side and to an exhaust air path on the outlet side. The anodes are each connected to an anode circuit. According to the invention, the exhaust air path of a fuel cell stack is connected to the anode and/or the cathode of a further fuel cell stack, so that the anode and/or the cathode of the further fuel cell stack can be inerted with the aid of the exhaust air from the other fuel cell stack.

The proposed fuel cell system is therefore particularly suitable for carrying out the method described above or can be operated according to this method, so that the same advantages can be achieved. In particular, the anode and/or the cathode of a fuel cell stack can be inerted easily and inexpensively during start-up and/or shutdown.

Preferably, the exhaust air path of one fuel cell stack is connected to the anode and/or the cathode of the other fuel cell stack via a connecting line with an integrated shut-off valve. This means that in the simplest case, the fuel cell system only needs to be extended by a connecting line with an integrated shut-off valve. This increases the installation space requirement of the fuel cell system only insignificantly.

The connecting line can be connected directly to the anode or the cathode of the fuel cell stack to be inerted. Alternatively, the connecting line can be connected indirectly via the anode circuit to the anode or indirectly via the feed air path to the cathode of the fuel cell stack to be inerted. The indirect supply of exhaust air is particularly easy to implement.

Furthermore, it is proposed that an air conveying and air compression system is integrated into the feed air path of at least one fuel cell stack. The air conveying and air compression system can be used to provide a certain air mass flow and a certain pressure level in the feed air path. If the fuel cell stack is to be inerted, the supply of oxygenated air can be interrupted by switching off the air conveying and air compression system.

Furthermore, a purge valve and/or a drain valve is/are preferably integrated into the anode circuit of at least one fuel cell stack. Anode gas can be discharged from the anode circuit by opening the purge and/or drain valve. This is particularly necessary if the anode is to be refilled with hydrogen after inerting.

### BRIEF DESCRIPTION OF THE DRAWINGS

Preferred embodiments of the invention are described in greater detail hereinafter with reference to the accompanying drawings. Shown are:

FIG. 1 a schematic representation of a first fuel cell system according to the invention,

FIG. 2 the sequence of a method according to the invention for operating the fuel cell system shown in FIG. 1,

FIG. 3 a schematic representation of a second fuel cell system according to the invention,

FIG. 4 the sequence of a method according to the invention for operating the fuel cell system shown in FIG. 3,

FIG. 5 a schematic representation of a third fuel cell system according to the invention,

FIG. 6 the sequence of a method according to the invention for operating the fuel cell system shown in FIG. 5 in the event of shutdown,

FIG. 7 the sequence of a method according to the invention for operating the fuel cell system shown in FIG. 5 in the event of start-up,

FIG. 8 the sequence of an alternative method according to the invention for operating a fuel cell system according to the invention in the event of start-up and

FIG. 9 a schematic representation of a fourth fuel cell system according to the invention.

### DETAILED DESCRIPTION

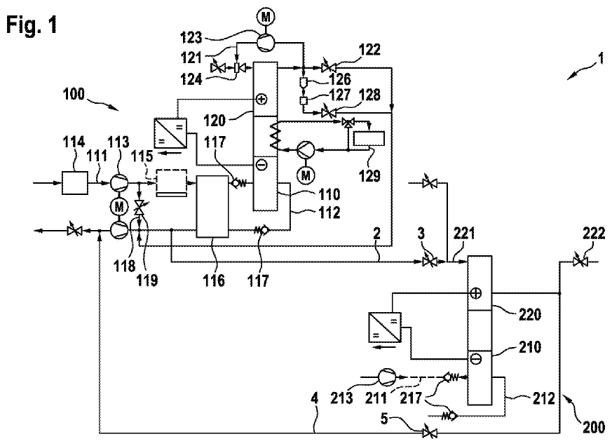

FIG. 1 shows a fuel cell system 1 according to the invention with a first fuel cell stack 100 and a second fuel cell stack 200.

The first fuel cell stack 100 has a cathode 110 and an anode 120. The cathode 110 is supplied with air as an oxygen supplier via a feed air path 111. The air is taken from the environment and fed via an air filter 114 to an air conveying and air compression system 113 in order to provide a certain air mass flow and a certain pressure level. As the air heats up, it is cooled with the aid of a heat exchanger 115 integrated into the feed air path 111 and humidified further downstream with the aid of a humidifier 116. The air then enters the cathode 110 of the fuel cell stack 100 via a first non-return valve 117.

The exhaust air from the fuel cell stack 100 is discharged via an exhaust air path 112, in which a further non-return valve 117 is arranged. Downstream of the non-return valve 117, the humidifier 116 is integrated into the exhaust air path 112 so that the humid exhaust air can be used to humidify the feed air. Downstream of the humidifier 116, the exhaust air is fed to a turbine 131 followed by a pressure regulator 130. With the aid of the turbine, some of the energy used for compression can be recovered, since the air conveying and air compression system 113 can be driven by means of the turbine 131. To bypass the fuel cell stack 100, the feed air path 111 and the exhaust air path 112 can be connected via a bypass path 118 with integrated bypass valve 119.

The anode 120 is supplied with fresh anode gas or hydrogen and recirculated anode gas via an anode circuit 121. Recirculation is achieved passively with the aid of a jet pump 124 and actively with the aid of a fan 123. Since the recirculated anode gas is enriched with nitrogen over time, which diffuses from the cathode side to the anode side, a purge valve 122 is provided in the anode circuit 121. By opening the purge valve 122, anode gas containing nitrogen is discharged from the anode circuit 121 and replaced by fresh anode gas via an open hydrogen metering valve (not shown). Since the recirculated anode gas is also enriched with water, a water separator 126 with a container 127 is integrated into the anode circuit 121. The container 127 can be emptied from time to time by opening a drain valve 128.

The heat generated during operation of the fuel cell stack 100 is discharged with the aid of a cooling circuit 129.

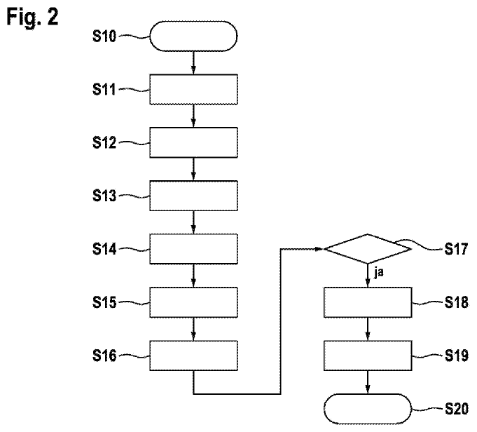

The exhaust air path 112 of the fuel cell stack 100 is connected to an anode circuit 221 of another fuel cell stack 200 via a connecting line 2 with integrated shut-off valve 3. When the shut-off valve 3 is open, exhaust air from the fuel cell stack 100 can thus be fed into the anode circuit 221. Anode gas enriched with exhaust air then enters an anode 220 of the fuel cell stack 200 via the anode circuit 221. The fuel cell system 1 shown in FIG. 1 can be operated according to the method described below and shown in FIG. 2 in the event of shutdown.

In step S10 of the method shown in FIG. 2, inerting of the anode 220 of the fuel cell stack 200 is started. For this purpose, the air supply to the fuel cell stack 200 is first shut off in step S11. If the cathode 210 can be shut off by shut-off valves, these are closed in step S12. In step S13, oxygen depletion of the cathode 210 of the fuel cell stack 200 then follows. The fuel cell stack 100 is operated in depletion operation in step S14, so that λₐᵢᵣ is ≤1. In step S15, the supply of fresh anode gas is interrupted by closing a hydrogen metering valve (not shown) and a purge valve 222 of the fuel cell stack 200. In step S16, the shut-off valve 3 in the connecting line 2 is then opened so that exhaust air from the exhaust air path 112 of the first fuel cell stack 100 enters the anode circuit 221 of the second fuel cell stack 200. In this way, the anode 220 of the second fuel cell system 200 is inerted. The completed inerting is checked in step S17. If the inerting of the anode 220 is determined (“yes”), the shut-off valve 3 in the connecting line 2 can then be closed again in step S18 and the depletion operation of the fuel cell stack 100 can be switched to normal operation in step S19, so that Nair is ≥1. The method ends in step S20.

The exhaust air from the first fuel cell stack 100 fed to the second fuel cell stack 200 can be removed again by opening the purge valve 222. Alternatively, it can be discharged into the exhaust air path 112 of the first fuel cell system 100 via a further connecting line 4 with integrated shut-off valve 5 (see FIG. 1). In this case, both shut-off valves 3 and 5 are opened in step S16 and both shut-off valves 3 and 5 are closed again in step S18.

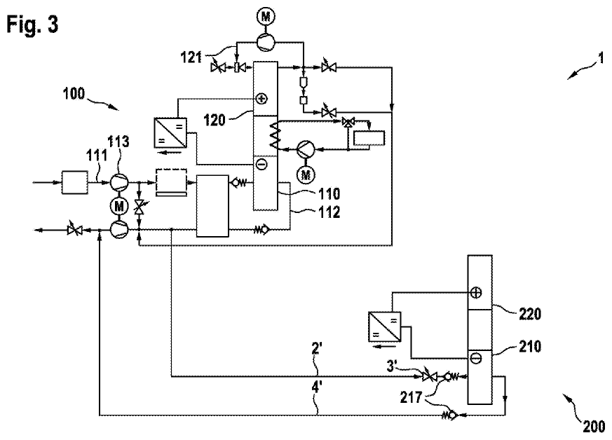

FIG. 3 shows a further fuel cell system 1 according to the invention with a first fuel cell stack 100 and a second fuel cell stack 200. These correspond to the two fuel cell stacks 100, 200 of the fuel cell system 1 shown in FIG. 1. In FIG. 3, however, the connecting lines 2′ and 4′ are not connected to the anode circuit 221 or the anode 220, but to the cathode 210 of the second fuel cell stack 200.

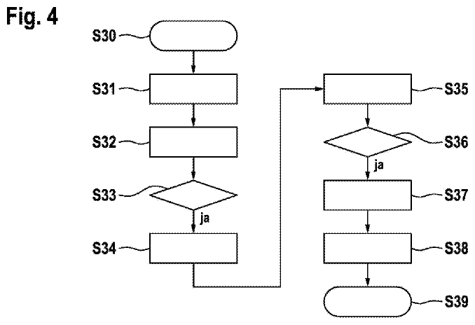

When the fuel cell system 1 is started, the cathode can be inerted in this way. For example, the method shown in FIG. 4 can be carried out.

In step S30 of the method shown in FIG. 4, inerting of the cathode 210 of the fuel cell stack 200 is started. For this purpose, the first fuel cell stack 100 is operated in depletion operation in step S31. In step S32, a shut-off valve 3′ integrated in the connecting line 2′ is opened. In step S33, it is checked whether the cathode 210 is inerted. If the result of the check is positive (“yes”), the shut-off valve 3′ is closed again in step S34.

If inerting of the anode 220 is also required, the fuel cell system 1 shown in FIG. 3 can be supplemented by the connecting lines 2, 4 and shut-off valves 3, 5 shown in FIG. 1. Step S34 is then followed by step S35, in which the shut-off valves 3, 5 are opened to inert the anode 220. Step S36 checks whether inerting has been completed. If this is the case (“yes”), the shut-off valves 3, 5 are closed again in step S37. Then, in step S38, the fuel cell stack 100 is switched from depletion operation to normal operation so that λₐᵢᵣ≥1. The method then ends in step S39.

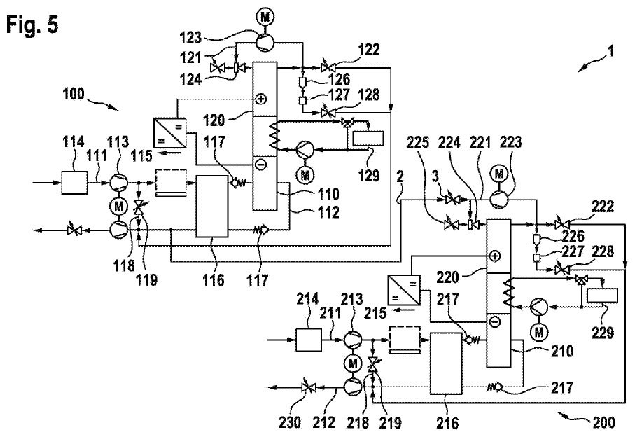

The inerting of the cathode 210 and the anode 220 therefore requires at least three shut-off valves 3, 3′ and 5. In order to reduce the number of shut-off valves 3, 3′, 5, the topology of the fuel cell system 1 can be further simplified, as shown in FIG. 5 as an example.

The fuel cell system 1 according to the invention shown in FIG. 5 has two fuel cell stacks 100, 200 which have essentially the same structure and correspond to the fuel cell stack 100 of the fuel cell system 1 of FIG. 1. The same reference symbols are therefore used. The two fuel cell stacks 100, 200 are connected via a connecting line 2 with integrated shut-off valve 3, wherein the connecting line 2 connects the exhaust air path 112 of the first fuel cell stack 100 with the anode circuit 221 of the second fuel cell stack 200.

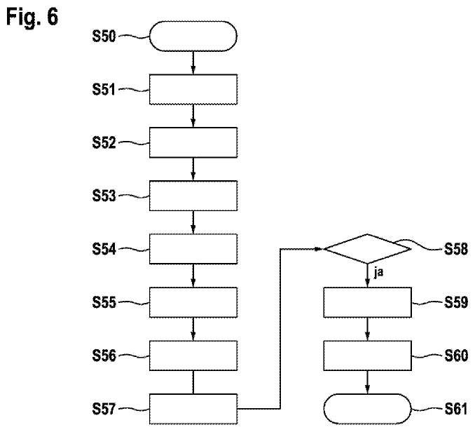

When switched off, the fuel cell system 1 can be operated according to the method shown in FIG. 6.

In step S50, the inerting of the fuel cell stack 200 is started. For this purpose, the air supply in the direction of the cathode 210 is interrupted in step S51 by switching off an air conveying and air compression system 213. If shut-off valves are provided in a feed air path 211 and/or in an exhaust air path 212, these are closed in step S52. In step S53, oxygen depletion of the cathode 210 of the fuel cell stack 200 then follows. The fuel cell stack 100 is operated in depletion operation in step S54, so that λₐᵢᵣ is ≤1. In step S55, a pressure regulator 225 arranged on the anode side of the fuel cell stack 200 to be inerted is closed. The shut-off valve 3 integrated in the connecting line 2 is then opened in step S56. In step S57, a purge valve 222 and/or a drain valve 228 of the fuel cell stack 200 to be inerted is/are then opened. Opening can also be timed. The exhaust air from the first fuel cell stack 100 fed via the connecting line 2 is then discharged again via the open purge valve 222 and/or the open drain valve 228. If a check carried out in step S58 shows that the anode 220 of the fuel cell stack 200 is inerted (“yes”), the shut-off valve 3, the purge valve 222 and/or the drain valve 228 can be closed again in step S59. In step S60, the depletion operation of the fuel cell stack 100 is switched back to normal operation so that λₐᵢᵣ≥1. The method ends in step S61.

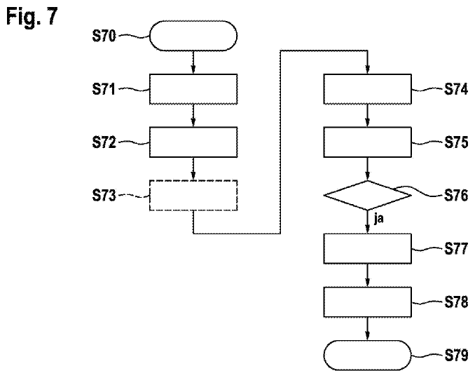

In the event of start-up, the method shown in FIG. 7 can be carried out.

In step S70 of the method shown in FIG. 7, inerting of the cathode 210 of the fuel cell stack 200 is started. For this purpose, the first fuel cell stack 100 is operated in depletion operation in step S71. In step S72, a pressure regulator 230 arranged in the exhaust air path 212 and a bypass valve 219 of a bypass path 218 of the fuel cell stack 200 to be inerted are closed. Instead of closing the pressure regulator 230 and/or the bypass valve 219 completely, they can also be throttled back considerably. If a shut-off valve is provided in the feed air path 211 and/or in the exhaust air path 212, these are closed in step S73. The shut-off valve 3 integrated in the connecting line 2 is then opened in step S74. In step S75, the purge valve 222 and/or the drain valve 228 is/are opened, possibly clocked, so that exhaust air from the exhaust air path 112 of the first fuel cell stack 100 flows into the anode circuit 221 of the second fuel cell stack 200 via the connecting line 2 and leaves again via the opened purge and/or drain valve 222, 228. Step S76 then checks whether the anode 220 is inerted. If the result of the check is positive (“yes”), the shut-off valve 3 and the purge and/or drain valve 222, 228 of the fuel cell stack 200 to be inerted are closed again in step S77. In step S78, the depletion operation of the first fuel cell stack 100 is switched back to normal operation, so that the method can be terminated in step S79.

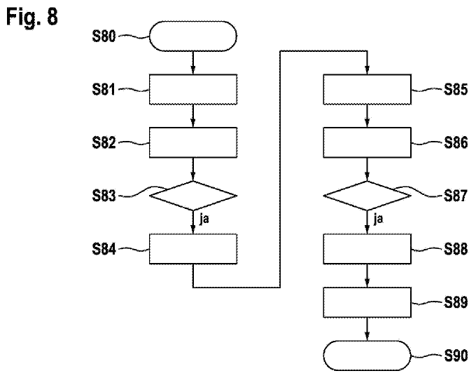

Alternatively, the method shown in FIG. 8 can be carried out in the event of start-up if the cathode 210 of the fuel cell stack 200 to be inerted is also connected to the exhaust air path 112 of the first fuel cell stack 100 via a connecting line 2′ with integrated shut-off valve 3′, as shown in FIG. 3.

In the method of FIG. 8, the inerting of the fuel cell stack 200 is initiated in step S80. For this purpose, the fuel cell stack 100 is operated in depletion operation in step S81. In step 82, the shut-off valve 3′ in the connecting line 2′ is then opened so that exhaust air from the exhaust air path 112 of the first fuel cell stack 100 is fed to the cathode 210 of the second fuel cell system 200. In step S83, it is checked whether the inerting of the cathode 210 is complete. If “yes”, the shut-off valve 3′ is closed in step S84. Then, in step S85, the shut-off valve 3 in the connecting line 2 is opened so that exhaust air from the exhaust air path 112 of the first fuel cell stack 100 enters the anode circuit 221 of the second fuel cell stack 200. Furthermore, in step S86, the purge valve 222 and/or the drain valve 228 of the fuel cell stack 200 to be inerted is/are opened, so that the quantity fed can be discharged again via this. Step S87 checks whether the inerting of anode 220 is complete. If “yes”, the shut-off valve 3 and the purge and/or drain valve 222, 228 are closed again in step S88. The depletion operation of the first fuel cell stack 100 is switched back to normal operation in step S89. The method ends in step S90.

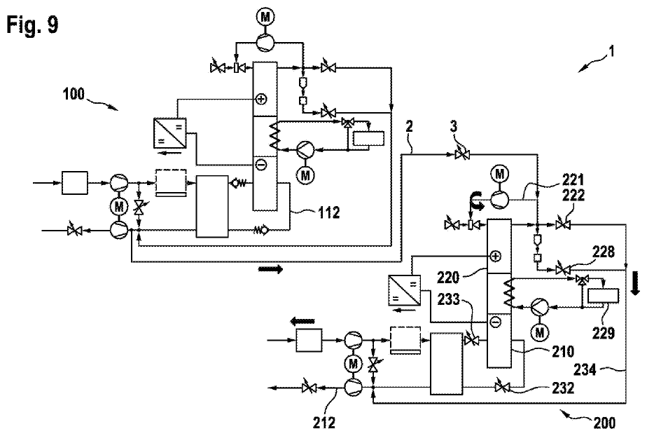

FIG. 9 shows a fuel cell system 1 with two fuel cell stacks 100, 200, wherein the fuel cell stack 200 has been modified. Instead of non-return valves 217, controllable shut-off valves 232, 233 are provided in the feed air path 211 and in the exhaust air path 212. By keeping the two shut-off valves 232, 233 open during the inerting of the anode 220, the cathode 210 can be inerted at the same time with the aid of the anode gas flowing out via the open purge valve 222 and/or open drain valve 228. For this purpose, the anode gas is introduced via a connecting line 234 into the exhaust air path 212 of the fuel cell stack 200 to be inerted and, with the shut-off valves 232, 233 open, is passed through the cathode 210 in the reverse direction of flow (see arrows in FIG. 9). In this way, both the anode 220 and the cathode 210 of the fuel cell stack 200 can be inerted with just one additional shut-off valve 3.

1. A method for operating a fuel cell system (1) having multiple fuel cell stacks (100, 200) which each have a cathode (110, 210) and an anode (120, 220), the cathodes (110, 210) each being fed with air via a feed air path (111, 211), and exhaust air emitted from the fuel cell stacks (100, 200) being discharged via an exhaust air path (112, 212), and the anodes (120, 220) each being supplied with hydrogen via an anode circuit (121, 221),
wherein when starting up and/or shutting down the fuel cell system (1), the exhaust air emitted from a fuel cell stack (100) is used for inerting the anode (220) and/or the cathode (210) of another fuel cell stack (200).

2. The method according to claim 1,
wherein the exhaust air of a fuel cell stack (100) used for inerting is fed to the further fuel cell stack (200) via a connecting line (2) with an integrated shut-off valve (3), which is opened for this purpose.

3. The method according to claim 1,
wherein the exhaust air of a fuel cell stack (100) used for inerting is fed to the anode (220) or the cathode (210) of the further fuel cell stack (200) directly or indirectly, preferably via the anode circuit (221) or the feed air path (211) of the further fuel cell stack (200).

4. The method according to claim 1,
wherein when the fuel cell system (1) is started and/or shut down, the air supply to the fuel cell stack (200) to be inerted is interrupted by switching off an air conveying and air compression system (213) and/or by closing at least one shut-off valve (217).

5. The method according to claim 1,
wherein by opening a purge valve (222) and/or drain valve (228) integrated in the anode circuit (221), anode gas of an inerted anode (220) is removed from the fuel cell system (1) or is introduced into an exhaust air path (112, 212) of a fuel cell stack (100, 200) via a connecting line (4).

6. The method according to claim 1,
wherein the exhaust air used for inerting is generated by sub-stoichiometric operation of a fuel cell stack (100, 200).

7. A fuel cell system (1) having multiple fuel cell stacks (100, 200) which each have a cathode (110, 210) and an anode (120, 220), the cathodes (110, 210) each being connected on an inlet side to a feed air path (111, 211) and on an outlet side to an exhaust air path (112, 212), and the anodes (120, 220) each being connected to an anode circuit (121, 221),
wherein the exhaust air path (112) of a fuel cell stack (100) is connected to the anode (220) and/or the cathode (210) of a further fuel cell stack (200), so that the anode (220) and/or the cathode (210) of the further fuel cell stack (200) can be inerted with the aid of the exhaust air.

8. The fuel cell system (1) according to claim 7,
wherein the exhaust air path (112) of a fuel cell stack (100) is connected to the anode (220) and/or the cathode (210) of the further fuel cell stack (200) via a connecting line (2) with an integrated shut-off valve (3).

9. A fuel cell system (1) according to claim 8,
wherein the connecting line (2) is connected directly to the anode (220) or the cathode (210) of the further fuel cell stack (200) to be inerted.

10. The fuel cell system (1) according to claim 8,
wherein the connecting line (2) is connected indirectly via the anode circuit (221) to the anode (220) or indirectly via the feed air path (211) to the cathode (210) of the further fuel cell stack (200) to be inerted.

11. The fuel cell system (1) according to claim 7, wherein an air conveying and air compression system (113, 212) is integrated into the feed air path (111, 211) of at least one fuel cell stack (100, 200).

12. The fuel cell system (1) according to claim 7,
wherein a purge valve (122, 222) and/or a drain valve (128, 228) is/are integrated in the anode circuit (121, 221) of at least one fuel cell stack (100, 200).
